(19) United States
(12) Patent Application Publication
(10) Pub. No.: US 2007/0104956 A1
(43) Pub. Date: May 10, 2007

(54) Polycarbonate system having enhanced weatherability and method of making same

(75) Inventor: Sunitha Grandhee, Novi, MI (US)

Correspondence Address: EXATEC;C/O BRINKS HOFER GILSON & LIONE, P. O. BOX 10395, CHICAGO, IL, 60610, US

(73) Assignee: EXATEC LLC

(21) Appl. No.: 11/271,467

(22) Filed: Nov. 10, 2005

(51) Int. Cl. B32B 27/36

(52) U.S. Cl. 428/412

(57) ABSTRACT

A polycarbonate system having enhanced weatherability is disclosed. The polycarbonate system comprises a substrate comprising a first surface and a second surface, a primer disposed on the first surface of the substrate, and a top coat disposed on the primer on the first surface for abrasion resistance. At least one of the primer and the top coat comprises an ultraviolet absorber in a solvent for ultraviolet absorption, the ultraviolet absorber having an extinction coefficient of ≧45,000 L-mol⁻¹ cm⁻¹ at λ=325 nm.

### TECHNICAL FIELD

The present invention relates to polycarbonate glazing systems having enhanced weatherability for vehicle windows.

### BACKGROUND OF THE INVENTION

Glass has been a component used for windows in the automotive industry. As known, glass provides a medium substrate treatable for abrasion resistance and ultraviolet resistance to be used as a window in vehicles. Although adequate, glass substrates are characteristically relatively heavy which translates to high costs in delivery and installment. Moreover, the weight of glass ultimately affects the total weight of the vehicle. Plastic materials have been used in a number of automotive engineering applications to substitute glass, enhance vehicle styling, and lower total vehicle weight and cost. An emerging application for transparent plastic materials is automotive window systems.

However, many manufacturers are faced with challenges with respect to polymeric articles having long term color instability, causing yellowing (termed “photoyellowing”) of the polymer and detracting from its transparency and attractiveness. In many instances, the yellowing of polymers is caused by the action of ultraviolet radiation. Abrasion resistance is also an issue of concern with such manufacturers.

Therefore, there is a need in the industry to formulate glass substitute such as plastic systems that are relatively lighter in weight without compromising functionality to protect the surface of the system.

### BRIEF SUMMARY OF THE INVENTION

The present invention generally provides a polycarbonate glazing system and method of enhancing weatherability. More specifically, the present invention provides a polycarbonate glazing system with enhanced abrasion resistance and ultraviolet resistance features.

In one embodiment, the present invention provides a polycarbonate system having enhanced weatherability. The system comprises a substrate comprising a first surface and a second surface, a primer disposed on the first surface of the substrate, and a top coat disposed on the primer on the first surface for abrasion resistance. At least one of the primer and the top coat comprising an ultraviolet absorber in a solvent for ultraviolet absorption, the ultraviolet absorber having an extinction coefficient of ≧45,000 L-mol⁻¹ cm⁻¹ at λ=325 nanometers (nm).

In another example, the present invention provides a method for making a polycarbonate system having enhanced weatherability. The method comprises adding an ultraviolet absorber solution to a mixture of diluted latex emulsions, wherein the ultraviolet absorber has an extinction coefficient of ≧45,000 L-mol⁻¹ cm⁻¹ at λ=325 nm to define a dispersion primer. The method further comprises applying the primer on a surface of a polycarbonate substrate. The method further comprises applying a top coat on the primer for abrasion resistance.

In another example, the method comprises mixing an ultraviolet absorber in a solvent at between about room temperature and about 50° C. for about twenty minutes defining an ultraviolet absorber solution and adding the ultraviolet absorber solution to a mixture of diluted latex emulsions, wherein the ultraviolet absorber has an extinction coefficient of ≧45,000 L-mol⁻¹ cm⁻¹ at λ=325 nm to define a dispersion primer. The method further comprises applying the primer on a surface of a polycarbonate substrate and drying the primer on the substrate at room temperature for about twenty minutes. The method further comprises curing the primer on the substrate at between about 120° C. and 130° C. for about thirty minutes and applying a top coat on the primer for abrasion resistance.

Further objects, features, and advantages of the present invention will become apparent from consideration of the following description and the appended claims when taken in connection with the accompanying drawings.

### BRIEF DESCRIPTION OF THE DRAWINGS

FIG. 1 is a cross-sectional view of the polycarbonate system depicted in accordance with one embodiment of the present invention; and

FIG. 2 is a cross-sectional view of the polycarbonate system 1 in accordance with another embodiment of the present invention.

### DETAILED DESCRIPTION OF THE INVENTION

The present invention generally provides a polycarbonate system having enhanced weatherability features including enhanced abrasion resistance and ultraviolet resistance. The polycarbonate system includes a polycarbonate substrate, a primer disposed on the polycarbonate substrate, and a top coat disposed on the primer. The primer comprises an unexpectedly compatible ultraviolet absorber in a solvent wherein the ultraviolet absorber has a relatively high extinction coefficient, low volatility, relatively high photostability. As a result, the polycarbonate system is provided with enhanced ultraviolet absorption.

One example of the present invention comprises vehicle window comprising a polycarbonate system 13 having enhanced weatherability in accordance with one embodiment of the present invention. In this embodiment, the polycarbonate system has enhanced weatherability including enhanced abrasion resistance and ultraviolet resistance. The system generally comprises a transparent plastic substrate, a primer disposed on the plastic substrate and having an ultraviolet absorber, and a top coat disposed on the primer.

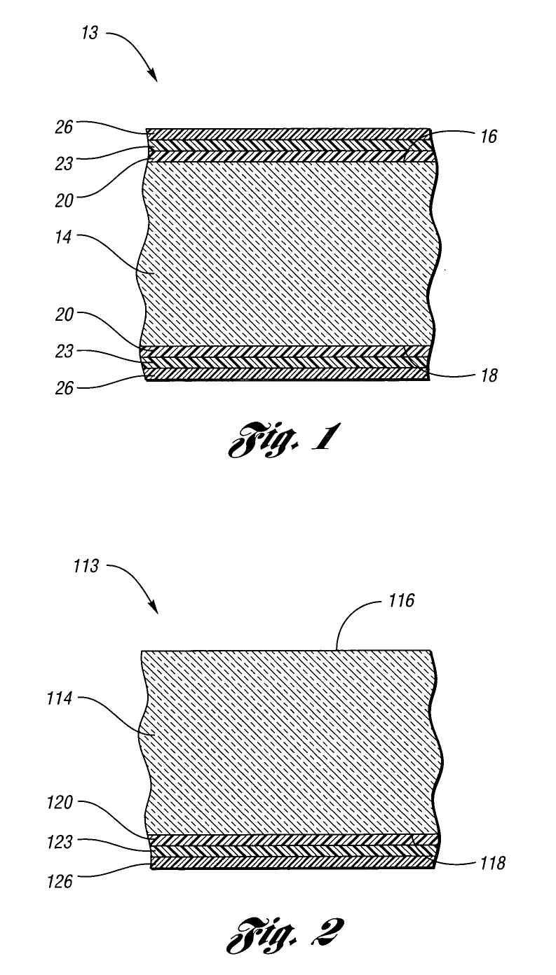

FIG. 1 depicts one example of a cross-section of the polycarbonate system 13. As shown, the polycarbonate system 13 includes a transparent plastic substrate 14 having a first surface 16 and a second surface 18. In this embodiment, the first surface 16 is an outer or “A” surface and the second surface 18 is an inner or “B” surface of the window 12.

In this embodiment, the transparent plastic substrate 14 comprises polycarbonate, acrylic, polyacrylate, polyester, polysulfone resins, or copolymers, or any other suitable transparent plastic material, and mixtures thereof. Preferably, the transparent plastic substrate includes bisphenol-A polycarbonate and other resin grades (such as branched or substituted) as well as being copolymerized or blended with other polymers such as polybutylene terephthalate (PBT), Poly-(Acrylonitrile Butadiene Styrene (ABS), or polyethylene. The transparent plastic substrate may further comprise various additives, such as colorants, mold release agents, antioxidants, and ultraviolet absorbers.

As shown in FIG. 1, a primer 20 is disposed on the transparent plastic substrate 14. The substrate 14 preferably comprises primer 20 applied on both the first surface 16 and second surface 18, although only one of its surfaces 16, 18 may have the primer 20 disposed thereon. As mentioned above, the primer includes an ultraviolet absorber in a solvent that provides enhanced weatherability, e.g., improved ultraviolet resistance. The primer 20 may be a waterborne primer or a solvent borne primer.

In one embodiment, the primer 20 comprises an ultraviolet absorber mixture of 2-(2-hydroxy-4-[1-octyloxycarbonylethoxy]phenyl)-4,6-bis(4-phenylphenyl)-1,3,5-triazine, water, ethylene glycol monobutyl ether, and polymethyl methacrylate. In another embodiment, the primer 20 is a solvent-borne primer, wherein water and ethylene glycol monobutyl ether are replaced with diacetone alcohol and 1-methoxy2-propanol.

In this example, the ultraviolet absorber has an extinction coefficient ε, wherein ε is preferably ≧45,000 L-mol⁻¹ cm⁻¹ at λ=325 nanometers (nm), more preferably ≧55,000 L-mol⁻¹ cm⁻¹ at λ=325 nm, and most preferably 65,000 L-mol⁻¹ cm⁻¹ at λ=325 nm.

In another embodiment, the primer 20 is a waterborne primer, generally comprising water as a first co-solvent and an organic liquid as a second co-solvent. In this embodiment, the second solvent generally comprises glycol ethers, ketones, alcohols, and acetates. Preferably, the first co-solvent comprises greater than 30 weight percent of the waterborne primer, more preferably greater than about 50 weight percent of the waterborne primer, and most preferably greater than at least 70 weight percent of the waterborne primer. As mentioned above, the general chemical classes associated with the second co-solvent preferably include glycol ethers, ketones, alcohols and acetates with the second co-solvent being present in less 70 weight percent of the waterborne primer. More preferably, the second co-solvent comprises less than about 50 weight percent of the waterborne primer, and most preferably less than about 30 weight percent of the waterborne primer.

For example, the second co-solvent may include 2-butoxyethanol (also called ethylene glycol monobutyl ether). The primer may contain other additives, such as but not limited to surfactants, antioxidants, biocides, and drying agents, among others. The ultraviolet absorber in the first and second co-solvents may include hydroxyphenyl-triazine, hydroxybenzophenones, hydroxyphenylbenzotriazoles, hydroxyphenyltriazines, polyaroylresorcinols, and cyanoacrylates.

The primer may be applied by any suitable atmospheric coating processes which includes but are not limited to curtain coating, spray coating, spin coating, dip coating, and flow coating.

As shown in FIG. 1, a topcoat 23 is applied on the primer 20 of the system 13 on each of the first and second surfaces 16, 18 thereof. The topcoat 23 adds additional or enhanced functionality to the polycarbonate system. Such enhanced functionality includes improved abrasion resistance and ultraviolet resistance. For example, the top coat 23 may be the hard-coat used in the Exatec® 900 glazing system. In the Exatec® 900 glazing system, the automotive glazing panel comprises a transparent polycarbonate substrate, an ink as discussed herein, a waterborne acrylic primer (Exatec® SHP 9X, Exatec LLC with GE Silicones), a silicone hard-coat (Exatec® SHX, Exatec LLC with GE Silicones), and a “glass-like” coat deposited using Plasma Enhanced Chemical Vapor Deposition.

The top coat 23 may include other suitable components for the polycarbonate system 13 of the present invention to enhance the functionality thereof. For example, other suitable components may include aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or glass, and mixtures thereof.

The topcoat 23 may be applied by any technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include but are not limited to plasma enhanced chemical vapor deposition, ion assisted plasma deposition, magnetron sputtering, electron beam evaporation, and ion beam sputtering. Examples of atmospheric coating processes include but are not limited to curtain coating, spray coating, spin coating, dip coating, and flow coating.

In this embodiment, the topcoat may be comprised of the ultraviolet absorber with any suitable material including polymethacrylate, polyacrylate, polyvinylidene fluoride, polyvinylfluoride, polypropylene, polyethylene, polyurethane, or a silicone hardcoat.

In one embodiment, the topcoat may also have the ultraviolet absorber (e.g., Tinuvin™ 479, an advanced triazine ultraviolet absorber from CIBA) mentioned above. The topcoat may be applied either on a primed substrate or it can be a primer-less topcoat.

In this embodiment, a decorative ink mixture may optionally be applied on the second surface 18 between the substrate 14 and the primer 20 for decorative purposes. In one embodiment, the decorative ink may comprise about 5 to 34 weight percent of a polyester resin obtained from a polyester ink and about 1 to 13 weight percent polycarbonate resin obtained from a polycarbonate ink. In this embodiment, the polyester ink and the polycarbonate ink have a weight ratio of up to about 100:0 and greater than about 50:50. The decorative ink further comprises about 0.1 to 5 weight percent isocyanate and a balance being a waterborne solvent. In this embodiment, a hard-coat is applied to the decorative ink so that the decorative ink adheres to the surface.

FIG. 2 illustrates a polycarbonate system 113 in accordance with another embodiment of the present invention. As shown, the polycarbonate system 113 includes a transparent plastic substrate 114 having first and second surfaces 116, 118. In this embodiment, the primer 120 is applied only to the second surface 118. Moreover the top coat 123 is applied to the primer 120 only on the second surface 118. The substrate 114, primer 120, and the top coat 123 are preferably comprised of the same material as respectively the substrate 14, the primer 20, and the top coat 23 mentioned above. In this embodiment, an ink mixture may also optionally be applied on the second surface 118 between the substrate 114 and the primer 120.

One example of the present invention includes a method of making a polycarbonate system having enhanced weatherability. In this example, the transparent plastic substrate is provided. Preferably, the substrate includes bisphenol-A polycarbonate and other resin grades (such as branched or substituted) as well as being copolymerized or blended with other polymers such as polybutylene terephthalate (PBT), Poly-(Acrylonitrile Butadiene Styrene (ABS), or polyethylene. The substrate preferably is formed into a window, e.g., vehicle window, through the use of any known technique to those skilled in the art, such as extrusion, molding, which includes injection molding, blow molding, and compression molding, or thermoforming, which includes thermal forming, vacuum forming, and cold forming. It is to be noted that the forming of a window using the substrate may occur prior to printing, after printing, or after application of the primer and top coat without falling beyond the scope or spirit of the present invention.

In this example, the method further comprises mixing the ultraviolet absorber in the first and second co-solvents mentioned above at about room temperature to about 50° C. for about 20 minutes, defining an ultraviolet absorber solution. Preferably, the first co-solvent is water and comprises greater than 10 weight percent of the waterborne primer. The second co-solvent preferably includes glycol ethers, ketones, alcohols and acetates. The second co-solvent is preferably present in less 90 weight percent of the waterborne primer.

The method further comprises adding the ultraviolet absorber solution to a mixture of diluted latex emulsions to define a dispersion primer. In this example, the ultraviolet absorber comprises hydroxyphenyl-triazine. The method further comprises applying the primer on a surface of the polycarbonate substrate mentioned above. In this example, the primer comprises a mixture of 2-(2-hydroxy-4-[1-octyloxycarbonylethoxy]phenyl)-4,6-bis(4-phenylphenyl)-1,3,5-triazine, ethylene glycol monobutyl ether, and polymethyl methacrylate.

The method then comprises drying the primer on the substrate at room temperature for about 20 minutes and curing the primer on the substrate at between about 120 and 130° C. for about 30 minutes.

The method further comprises applying a top coat on the primer for abrasion resistance. In this example, the top coat is a silicone hard-coat having an abrasion resistance material. The abrasion resistance material may comprise aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or glass, or a mixtures thereof.

### EXAMPLES

This example provides an improved weatherability of polycarbonate glazing system using ultraviolet absorber such as a hydroxyphenyl-triazine (e.g. Tinuvin™ 479). In this example, experiments were conducted to incorporate ultraviolet absorbers in the primer. For this example, Tinuvin™ 479, an advanced triazine ultraviolet absorber from CIBA was chosen.

Primer Formulation

The primer used in this example system was waterborne and comprised of emulsion polymers Hycar™ 26237 and Hycar™ 26256. Hycar™ 26237 is an acrylic copolymer latex, having a weight of latex of 9.1 lbs/gal and a weight of solids of 4.4 lbs/gal. The Hycar™ 26237 had properties as follows: pH: 2.5; total solids: 50.5 weight %; viscosity: 140 cp; surface tension: 43 dynes/cm; specific gravity-latex: 1.091; and specific gravity-polymer: 1.210. The Hycar™ 26256 is a synthetic anionic acrylic copolymer latex, having a weight of latex of 9.1 lbs/gal and a weight of solids of 4.4 lbs/gal. The Hycar™ 26256 had properties as follows: pH: 2.5; total solids: 49.5 weight %; viscosity: 120 csp; surface tension: 43 dynes/cm; specific gravity-latex: 1.09; and specific gravity-polymer: 1.20.

An ultraviolet absorber Uvinul™ 3039 was included in the control formulation. Uvinul™ 3039 is 2-ethylhexyl-2-cyano-3,3-diphenylacrylate, a clear yellowish liquid with a molecular weight of 361 in this example. The formula of the control is provided below labeled “Control Formula A.”

An ultraviolet absorber Tinuvin™ 479 from Ciba was used in the example formula. The ultraviolet absorber Tinuvin™ 479 is 2-(2-hydroxy-4-[1-octyloxycarbonylethoxy]phenyl)-4,6-bis(4-phenylphenyl)-1,3,5-triazine.

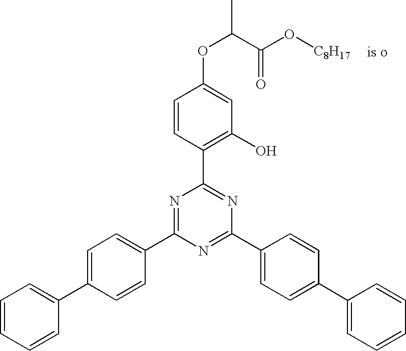

The formulas of the samples are provided below labeled “Samples A-E.”

Control Formula A

The control formula A was made by the method provided below. About 60 parts of Deionized water was weighed out in a container. About 0.02 parts of citric acid was then added and the mixture was agitated for about 15 minutes. To this mixture, about 2.4 parts of Hycar™ 26237 and about 2.4 parts of Hycar™ 26256 were added. The mixture was then agitated for about 10 minutes. A solution of the Uvinul™ 3039 was made in 26 parts of 2-ethoxybutanol and the solution was then added to the emulsion mixture, relatively slowly while stirring continuously. The resulting mixture was mixed for about 15 minutes, and then filtered.

Table A

Formulas Containing Tinuvin™ 479

TABLE A

| | 100% | 100% | 100% | 100% |
|---|---|---|---|---|
| | B | C | D | E |
| D.I. water | 57.63 | 57.63 | 57.63 | 57.63 |
| Citric acid | 0.03 | 0.03 | 0.03 | 0.03 |
| Hycar 237 | 4.80 | 4.80 | 4.80 | 2.40 |
| Hycar 256 | 4.80 | 4.80 | 4.80 | 2.40 |
| Tinuvin 479 | 0.2 | 0.405 | 0.81 | 1.62 |
| 2-Ethoxybutanol | 36.06 | 36.06 | 36.06 | 36.06 |
| BOF | 0.2 | 0.405 | 0.81 | 1.62 |
| BOS | 4 | 7.78 | 14.44 | 40.29 |

Procedure

DI Water was weighed in a container. Citric acid was then weighed in the container and the mixture was kept under slow agitation, while the two Hycar™ 26256 and 26237 emulsions were weighed and added to the container. After mixing for about 15 minutes under slow agitation, the ultraviolet absorber Tinuvin™ 479 and 2-ethoxybutanol was weighed separately, mixed and later added to the bulk container. The mixture was then agitated for about 30 minutes, and then filtered. The percent solids was found to be between about 3.5 and 4 weight percent.

Coating Application

Molded polycarbonate sheets (about 730 mm each) were cleaned with 2-isopropanol, and then dried using ionized air. The sheets were printed with two strips (approximately 5 inches in width) of 8 micron (dry film) black ink. The primer solutions were then applied on these sheets by a flow coating process, under booth conditions with the temperature at between about 20 and 25° C. and relative humidity of approximately 40%. The sheets were flashed at room temperature for 20 minutes followed by baking at 125° C. for 60 minutes. The thickness was found to be between about 0.2 and 1.0 micron.

Results

The substrates (or primed plaques) were topcoated with a silicone hardcoat, followed by a siloxane plasma layer. The plaques were tested for adhesion, appearance and ultraviolet absorbance. Adhesion was tested both on the ink as well as non-ink parts, on the top, middle and bottom parts of the plaques. The test used to check adhesion, involved immersing the part in water maintained at a temperature of about 65 C for 10 days. The water immersion test included an initial cross-hatch adhesion test (tape pull) according to ASTM D3359-95 followed by submersing the printed and coated plastic substrate in distilled water at elevated temperatures around 65° C. for approximately 10 days. The adhesion of the ink and primer/hard-coat and any optional topcoat applied either on top of or beneath the hard-coat is tested periodically up to the maximum of 10 days. As shown below, the results (% adhesion) of the adhesion test showed that the non-ink (Table B) and ink areas had relatively adhesive qualities (>90%). (Table C)

TABLE B
Water Immersion 65 C. (Non-Ink Area)

| | DAY 0 | DAY 1 | DAY 3 | DAY 7 | DAY 10 | ASTM |
|---|---|---|---|---|---|---|
| A(control) | | | | | | |
| TOP | 100A | 97B | 96C | 95C | 93C | 100A |
| MID | 100A | 99A | 99A | 99A | 99A | 99A |
| BOT | 99B | 99B | 99B | 99B | 99B | 99B |
| B | | | | | | |
| TOP | 100A | 99B | 99C | 99C | 99C | 99A |
| MID | 99A | 99A | 99A | 99B | 99B | 99B |
| BOT | 99A | 99B | 99B | 99B | 99B | 99B |
| C | | | | | | |
| TOP | 100A | 100A | 100A | 100A | 99B | 100A |
| MID | 99A | 99A | 99A | 99A | 99B | 99A |
| BOT | 99A | 99B | 99B | 99B | 99B | 99B |
| D | | | | | | |
| TOP | 100A | 100A | 99B | 99B | 98C | 100A |
| MID | 100A | 99B | 99B | 99B | 99B | 99A |
| BOT | 99A | 99A | 99B | 99B | 99B | 99B |
| E | | | | | | |
| TOP | 100A | 99B | 99B | 99B | 99B | 100A |
| MID | 99A | 99A | 99B | 99B | 99B | 99B |
| BOT | 99A | 99B | 99B | 99B | 99B | 99B |

TABLE C
Water Immersion 65 C. (Ink Area)

| | | DAY 0 | DAY 1 | DAY 3 | DAY 7 | DAY 10 | ASTM |
|---|---|---|---|---|---|---|---|
| A | | | | | | | |
| (con- | | | | | | | |
| trol) | CTL | | | | | | |
| TOP | TOP | 100A | 100A | 100A | 100A | 100A | 100A |
| MID | MID | 100A | 99A | 99A | 99A | 99A | 100A |
| BOT | BOT | 99A | 99B | 99B | 99B | 99B | 99B |
| B | B | | | | | | |
| TOP | TOP | 100A | 100A | 100A | 100A | 100A | 100A |
| MID | MID | 99A | 99A | 99B | 99B | 99B | 100A |
| BOT | BOT | 99A | 99B | 99B | 99B | 99B | 99B |
| C | C | | | | | | |
| TOP | TOP | 100A | 100A | 100A | 100A | 100A | 100A |
| MID | MID | 100A | 99B | 99B | 99B | 99B | 9A |
| BOT | BOT | 99A | 99B | 99B | 99B | 99B | 100B |
| D | D | | | | | | |
| TOP | TOP | 100A | 99B | 99B | 99B | 99B | 100A |
| MID | MID | 100A | 99B | 99B | 99B | 99B | 100A |
| BOT | BOT | 99A | 99B | 99B | 99B | 99B | 99B |
| E | E | | | | | | |
| TOP | TOP | 100A | 99B | 99B | 99B | 99B | 100A |
| MID | MID | 99A | 99A | 99B | 99B | 99B | 99A |
| BOT | BOT | 99A | 99B | 99B | 99B | 99B | 99B |

Adhesion of the primer formulas containing Tinuvin™ 479 was found to be relatively good and comparable with the control formula containing Uvinul™ 3038.

Ultraviolet Absorbances

The primer solutions were applied on the substrates or polycarbonate plaques, not containing ultraviolet absorbers. The thickness of the primer was measured and the ultraviolet index was measured using the Varian Cary 500 UV Vis NIR Spectrophotometer at 340 nm. As shown in the Table D below, the ultraviolet absorbance of the primer increases as the ultraviolet absorber concentration increases therein, indicating a favorable UV absorbance utility in the primer.

TABLE D

| | | Conc | | Abs/micron | |
|---|---|---|---|---|---|
| UVA | Sample | BOF | BOS | Topcoat | Primer |
| Uvinul | Control | 1.30 | 22.00 | 0.19 | 0 |
| 3039 | | | | | |
| Tin 479 | B | 0.20 | 4.00 | 0.173 | 0.02 |
| Tin 479 | C | 0.40 | 7.78 | 0.226 | 0.50 |
| Tin 479 | D | 0.80 | 14.46 | 0.293 | 1.38 |
| Tin 479 | E | 1.60 | 40.29 | 0.4 | 1.89 |

BOF—Based on total primer formula
BOS—Based on solids only

While the present invention has been described in terms of preferred embodiments, it will be understood, of course, that the invention is not limited thereto since modifications may be made to those skilled in the art, particularly in light of the foregoing teachings.

1. A polycarbonate system having enhanced weatherability, the system comprising:
a substrate comprising a first surface and a second surface;
a primer disposed on the first surface of the substrate; and
a top coat disposed on the primer on the first surface for abrasion resistance, at least one of the primer and the top coat comprising an ultraviolet absorber in a solvent for ultraviolet absorption, the ultraviolet absorber having an extinction coefficient of ≧45,000 L-mol⁻¹ cm⁻¹ at λ=325 nm.

2. The system of claim 1 wheren the substrate is transparent.

3. The system of claim 2 wherein the substrate is an automotive window.

4. The system of claim 1 wherein the ultraviolet absorber has an extinction coefficient of ≧55,000 L-mol⁻¹ cm⁻¹ at λ=325 nm.

5. The system of claim 1 wherein the ultraviolet absorber has an extinction coefficient of ≧65,000 L-mol⁻¹ cm⁻¹ at λ=325 nm.

6. The system of claim 1 wherein the primer is disposed on the second surface of the substrate and the top coat is disposed on the primer on the second surface.

7. The system of claim 6 wherein the primer comprises 2-(2-hydroxy-4-[1-octyloxycarbonylethoxy]phenyl)-4,6-bis(4-phenylphenyl)-1,3,5-triazine and polymethyl methacrylate.

8. The system of claim 7 further comprising an abrasion resistance material disposed on the top coat on the first and second surfaces.

9. The system of claim 8 further comprising a layer of ink disposed on a portion of the substrate on the second surface.

10. The system of claim 9 wherein the ink comprises a synthetic resin, the synthetic resin being a polycarbonate resin or a polyester resin or a mixture thereof.

11. The system of claim 8 further comprising an abrasion resistance material disposed on the top coat.

12. The system of claim 11 wherein the abrasion resistance material comprises aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or glass, or a mixtures thereof.

13. The system of claim 1 wherein the primer comprises one of a waterborne primer and a solvent borne primer.

14. The system of claim 1 wherein the primer comprises 2-(2-hydroxy-4-[1-octyloxycarbonylethoxy]phenyl)-4,6-bis(4-phenylphenyl)-1,3,5-triazine and polymethyl methacrylate.

15. The system of claim 1 wherein the ultraviolet absorber comprises a hydroxyphenyl-triazine.

16. The system of claim 1 wherein the solvent comprises a first co-solvent and a second co-solvent.

17. The system of claim 16 wherein the first co-solvent comprises water and the second co-solvent comprises glycol ethers, ketones, alcohols, or acetates or a mixture thereof.

18. The system of claim 16 wherein each of the first and the second co-solvents comprise glycol ethers, ketones, alcohols, or acetates or a mixture thereof.

19. The system of claim 1 wherein the substrate comprises polycarbonate, polyethylene, or polypropylene, or a mixture thereof.

20. The system of claim 1 wherein the top coat comprises the ultraviolet absorber and at least one of the following materials: polymethyl-methacrylate, polyvinylidene fluoride, polyvinylfluoride, polypropylene, polyethylene, polyurethane, and silicone.

21. A method of making a polycarbonate system having enhanced weatherability, the method comprising:
adding an ultraviolet absorber solution to a mixture of diluted latex emulsions to define a dispersion primer, the ultraviolet absorber having an extinction coefficient of ≧45,000 L-mol⁻¹ cm⁻¹ at λ=325 nm;
applying the primer on a surface of a polycarbonate substrate; and
applying a top coat on the primer for abrasion resistance.

22. The method of claim 21 wherein the top coat comprises the ultraviolet absorber.

23. The method of claim 22 wherein adding includes mixing an ultraviolet absorber in a solvent from about room temperature to about 50° C. for 20 minutes defining an ultraviolet absorber solution.

24. The method of claim 22 wherein applying the primer includes:
drying the primer on the substrate at room temperature for about 20 minutes; and
curing the primer on the substrate at between about 120 and 130° C. for about 30 minutes; and

25. A method of making a polycarbonate system having enhanced weatherability, the method comprising:
mixing an ultraviolet absorber in a solvent at between about room temperature and about 50° C. for 20 minutes, the ultraviolet absorber having an extinction coefficient of ≧45,000 L-mol⁻¹ cm⁻¹ at λ=325 nm, defining an ultraviolet absorber solution;
adding the ultraviolet absorber solution to a mixture of diluted latex emulsions to define a dispersion primer;
applying the primer on a surface of a polycarbonate substrate;
drying the primer on the substrate at room temperature for about 20 minutes;
curing the primer on the substrate at between about 120 and 130° C. for about 30 minutes; and
applying a top coat on the primer for abrasion resistance.

26. The method of claim 25 wherein the absorbance value from the primer is at least 0.5.

27. The method of claim 25 wherein the ultraviolet absorber comprises a hydroxyphenyl-triazine.
